(19) United States
(12) Patent Application Publication
(10) Pub. No.: US 2025/0065610 A1
(43) Pub. Date: Feb. 27, 2025

(54) Transparent Plastic Sheet for Blocking Ultraviolet and Infrared Rays

(71) Applicant: Idel Co., Ltd., Chilgok-gun (KR)

(72) Inventors: Jae Sik Lee, Daegu (KR); Ki Sung Nam, Cheongju-si (KR); Yong Hyeok Choi, Busan (KR); Yeong Min Lee, Daegu (KR); Seong Hyeon Nam, Daegu (KR); Su Min Ha, Daegu (KR)

(21) Appl. No.: 18/811,081

(22) Filed: Aug. 21, 2024

(30) Foreign Application Priority Data
Aug. 25, 2023 (KR) 10-2023-0112303

(51) Int. Cl. B32B 27/08; B29C 48/21; B32B 27/20; B32B 27/36

(52) U.S. Cl. CPC B32B 27/08; B29C 48/21; B32B 27/20; B32B 27/365; B32B 2264/102; B32B 2264/12; B32B 2264/301; B32B 2264/302; B32B 2264/303; B32B 2307/412; B32B 2307/71; B32B 2369/00

(57) ABSTRACT

Proposed is a transparent plastic sheet for blocking ultraviolet and infrared rays, the sheet including a base layer including a thermoplastic polymer and a skin layer provided on one or each side of the base layer and including a thermoplastic polymer, a ultraviolet blocking agent, an antioxidant, and an infrared blocking agent, in which the base layer and the skin layer are formed by a co-extrusion method.

### CROSS REFERENCE TO RELATED APPLICATION

The present application claims priority to Korean Patent Application No. 10-2023-0112303, filed Aug. 25, 2023, the entire contents of which is incorporated herein for all purposes by this reference.

### BACKGROUND OF THE INVENTION

### Field of the Invention

The present disclosure relates to a transparent plastic sheet for blocking ultraviolet and infrared rays.

### Description of the Related Art

In general, polycarbonate sheets are widely used as a substitute for glass in building materials such as skylights, building light panels, roofing materials, canopies, window or safety glass, swimming pools, indoor gym roofs, greenhouses, or soundproof walls.

These polycarbonate sheets are usually manufactured by extrusion molding and have excellent transparency and strength.

Sunlight is largely divided into three components: ultraviolet, visible, and infrared rays. Of the total sunlight composition, ultraviolet rays account for approximately 6%, visible rays account for approximately 46%, and infrared rays account for approximately 48%.

Infrared rays, which account for almost half of sunlight but do not contribute to lighting and cause heating, are classified into near-infrared rays (0.75 to 3 μm), infrared rays (3 to 25 μm), and far-infrared rays (25 μm or more) depending on the wavelength. The infrared rays are characterized by a stronger heating effect than visible rays or ultraviolet rays, and for this reason, they are also called heat rays.

Radiant heat transmitted from the sun or a heating element to spaces is mainly caused by the infrared rays. However, the conventional polycarbonate sheet used in outdoor structures has a low infrared blocking rate, so it is problematic in that the internal temperature of the structure increases in the summer and the sheet bends due to thermal expansion and contraction.

In an effort to solve this problem, various methods have been attempted to achieve an insulating effect, such as using milky white polycarbonate sheets or stacking infrared reflective films.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent No. 10-0900194 (published on 2009 Jun. 2.)

### SUMMARY OF THE INVENTION

Accordingly, the present disclosure has been made keeping in mind the above problems occurring in the related art, and one objective of the present disclosure is to provide a transparent plastic sheet with an improved ultraviolet and infrared blocking rate while maintaining transparency.

Another objective of the present disclosure is to provide a transparent plastic sheet that has a superior infrared blocking rate by including a specific combination of infrared blocking agents in a skin layer compared to when using a single infrared blocking agent.

In order to achieve the above objectives, according to one aspect of the present disclosure, there is provided a transparent plastic sheet for blocking ultraviolet and infrared rays, the sheet including: a base layer including a thermoplastic polymer; and a skin layer provided on one or each side of the base layer and including a thermoplastic polymer, an ultraviolet blocking agent, an antioxidant, and an infrared blocking agent, in which the base layer and the skin layer may be formed by a co-extrusion method.

Additionally, the infrared blocking agent may be one or more selected from the group consisting of zinc oxide, tungsten oxide, and aluminum-doped tungsten oxide. Specifically, the infrared blocking agent may include 70 to 80% by weight of the tungsten oxide and 20 to 30% by weight of the aluminum-doped tungsten oxide.

Additionally, the infrared blocking agent may have the form of particles having a particle size of 1 nm to 100 μm. Additionally, the skin layer may include 83 to 98% by weight of the thermoplastic polymer, 0.3 to 15% by weight of the ultraviolet blocking agent, 0.1 to 2% by weight of the antioxidant, and 0.01 to 0.5% by weight of the infrared blocking agent.

Additionally, the skin layer may have a thickness of 0.01 to 0.5 mm.

Additionally, the thermoplastic polymer may be one or more selected from the group consisting of polycarbonate (PC), polyethylene terephthalate (PET), polyethylene terephthalate glycol (PETG), polycyclohexylene dimethylene terephthalate glycol (PCTG), polymethyl methacrylate (PMMA), and polystyrene (PS). Specifically, the thermoplastic polymer may be polycarbonate.

The present disclosure can provide a transparent plastic sheet with an improved ultraviolet and infrared blocking rate while maintaining transparency.

Additionally, the present disclosure can provide a transparent plastic sheet that has a superior infrared blocking rate by including a specific combination of infrared blocking agents in a skin layer compared to when using a single infrared blocking agent.

Additionally, it is possible to manufacture a sheet for blocking ultraviolet infrared rays using a mixture of infrared blocking agents with a relatively low cost, thereby reducing manufacturing cost.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates a view of a transparent plastic sheet for blocking ultraviolet and infrared rays according to an embodiment of the present disclosure;

FIGS. 2A to 2C illustrate views of the results of measuring infrared transmittance according to component and content of infrared blocking agents;

FIG. 3 illustrates views of the results of comparing infrared transmittance when infrared blocking agent are used singly or in a combination thereof;

FIG. 4 illustrates an image of a test device that measures a temperature rise inhibition effect; and

FIG. 5 illustrates a view of the results of analyzing the temperature rise inhibition effect.

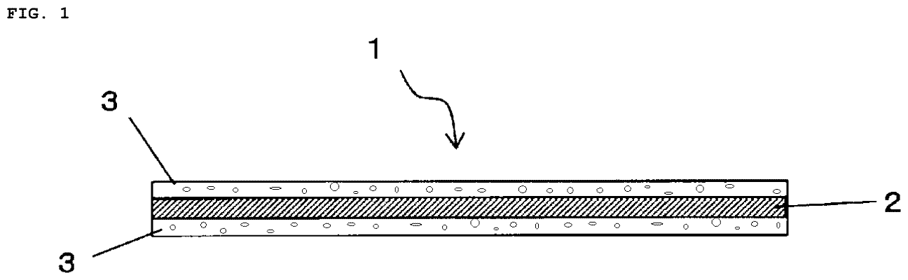

### DETAILED DESCRIPTION OF THE INVENTION

Hereinbelow, an exemplary embodiment of the present disclosure will be described in detail with reference to the accompanying drawings such that the present disclosure can be easily embodied by one of ordinary skill in the art to which the present disclosure belongs. The embodiment of the present disclosure may be changed to a variety of embodiments and the scope and spirit of the present disclosure are not limited to the embodiment described herein below. Throughout the drawings, the same reference numerals will refer to the same or like parts.

In one aspect, the present disclosure provides a transparent plastic sheet 1 for blocking ultraviolet and infrared rays, the plastic sheet including a base layer 2 including a thermoplastic polymer and a skin layer 3 including a thermoplastic polymer, a ultraviolet blocking agent, an antioxidant, and an infrared blocking agent and provided on one or each side of the base layer 2, in which the base layer 2 and the skin layer 3 are formed by a co-extrusion method.

The term “co-extrusion” used herein may be used when producing an extrusion coating, film, or sheet using two or more extruders, and refers to a general method of creating a multi-layer structure by adding one or more types of layers.

In this specification, co-extrusion is not particularly limited, and a sheet composed of a base layer and a skin layer may be manufactured through a general co-extrusion process. Additionally, in the co-extrusion process, there may be provided a method in which the base layer and the skin layer pushed out from two or more extruders may meet at a feed block and are molded to a predetermined thickness on a calender roll, or a method in which the base layer and the skin layer are co-extruded through one extrusion die using a plurality of nozzles, but the present disclosure is not limited thereto.

The term “thermoplastic polymer” used herein refers to a polymer that melts when heat is applied and returns to a solid state when its temperature is sufficiently lowered. The thermoplastic polymer may be one or more types selected from the group consisting of polycarbonate (PC), polyethylene terephthalate (PET), polyethylene terephthalate glycol (PETG), polycyclohexylene dimethylene terephthalate glycol (PCTG), polymethyl methacrylate (PMMA), and polystyrene (PS), and specifically may be polycarbonate.

The thickness of the base layer 2 is not particularly limited, but preferably is 1 to 8 mm.

The skin layer 3 may be formed on one or each side of the base layer 2, and may be formed on each side of the base layer 2 to increase ultraviolet and infrared blocking efficiency.

The skin layer 3 may have a thickness of 0.01 to 0.5 mm, specifically 0.05 to 0.4 mm, and more specifically 0.05 to 0.2 mm.

When the thickness of the skin layer 3 is less than 0.01 mm, ultraviolet and infrared blocking efficiency may be reduced, and when it exceeds 0.5 mm, transparency may be reduced.

The skin layer 3 may include the thermoplastic polymer, the ultraviolet blocking agent, the antioxidant, and the infrared blocking agent. Specifically, the skin layer 3 may include 83 to 98% by weight of the thermoplastic polymer, 0.3 to 15% by weight of the ultraviolet blocking agent, 0.1 to 2% by weight of the antioxidant, and 0.01 to 0.5% by weight of the infrared blocking agent.

The skin layer 3 may include 83 to 98% by weight of the thermoplastic polymer, and specifically 90 to 95% by weight. When the content of the thermoplastic polymer in the skin layer 3 is less than 83% by weight, mechanical properties of the sheet may be reduced, and when it exceeds 98% by weight, an ultraviolet and infrared blocking effect may be reduced due to the excessive content.

The thermoplastic polymer in the skin layer 3 may be the same as the thermoplastic polymer in the base layer 2.

The skin layer 3 may include 0.3 to 15% by weight of the ultraviolet blocking agent, and specifically 4 to 9% by weight. When the content of the ultraviolet blocking agent in the skin layer 3 is less than 0.3% by weight, an ultraviolet blocking effect may not be achieved, and when it exceeds 15% by weight, mechanical properties of the skin layer 3 and the sheet may be reduced.

When the content of the ultraviolet blocking agent is within the above range, an ultraviolet blocking efficiency of more than 70% may be achieved.

The ultraviolet blocking agent may be one or more selected from the group consisting of benzotriazole-based, hindered amine-based, benzophenone-based, and salicylate-based types. As the benzotriazole-based type, there may be used commercially available ultraviolet blocking agents having the trade designation Tinuvin® 234 (Basf), Tinuvin® 237 (Basf), Tinuvin® 239 (Basf), Tinuvin® 360 (Basf), Tinuvin® 1577 (Basf), SONGSORB® 2340 (Songwon Industrial), SONGSORB® 2370 (Songwon Industrial), SONGSORB® 3290 (Songwon Industrial), SONGSORB® 3600 (Songwon Industrial), and SONGSORB® 1577 (Songwon Industrial). As the salicylate-based type, there may be used an ultraviolet blocking agent having the trade designation HOSTAVIN B-CAP (manufactured by Clariant Co., Ltd.).

The skin layer 3 may include 0.1 to 2% by weight of the antioxidant, and specifically 0.3 to 1% by weight.

When the content of the antioxidant in the skin layer 3 is less than 0.1% by weight, the desired antioxidant effect may not be achieved, and when it exceeds 2% by weight, physical properties of the skin layer 3 may be reduced.

Additionally, as the antioxidant, it is preferable to use a mixture of a phenol-based primary antioxidant and a phosphorus-based secondary antioxidant. In this case, 0.05 to 1% by weight of each antioxidant may be used.

As the phenol-based primary antioxidant, there may be used a commercially available antioxidant having the trade phosphorus-based designation Irganox 1076 (BASF). As the secondary antioxidant, there may be used a commercially available antioxidant having the trade designation Irgafos 168 (BASF).

The skin layer 3 may include 0.01 to 0.5% by weight of the infrared blocking agent, and specifically, 0.04 to 0.15% by weight.

When the content of the infrared blocking agent in the skin layer 3 is less than 0.01% by weight, an infrared blocking effect may not be achieved, and when it exceeds 0.5% by weight, an expected effect may not be achieved compared to an added amount and transparency may be reduced.

The infrared blocking agent may be one or more selected from the group consisting of zinc oxide, tungsten oxide, and aluminum-doped tungsten oxide. Specifically, as the infrared blocking agent, 70 to 80% by weight of tungsten oxide and 20 to 30% by weight of aluminum doped tungsten oxide may be used, and more specifically, 75 to 80 wt % of tungsten oxide and 20 to 25 wt % of aluminum-doped tungsten oxide may be used. When the mixing ratio of tungsten oxide and aluminum-doped tungsten oxide is within the above range, a superior infrared blocking effect may be achieved compared to when they are used singly. The infrared blocking agent may have the form of particles. Specifically, the infrared blocking agent may have a particle size of 1 nm to 100 μm, and more specifically, may have a particle size of 1 nm to 10 μm.

The transparent plastic sheet 1 for blocking ultraviolet and infrared rays according to the present disclosure may exhibit excellent ultraviolet and infrared blocking efficiency when it is composed of the ingredients and composition within the above-mentioned range.

Hereinbelow, the present disclosure will be described in more detail with examples. These examples are only for illustrating the present disclosure in more detail, and it is apparent to those skilled in the art that the scope of the present disclosure is not limited thereto.

### TEST EXAMPLE

### Test Example 1: Analysis of Ultraviolet and Infrared Blocking Effect

Plastic sheets were manufactured by co-extrusion to form a skin layer on each side of a base layer according to the ingredient list in Table 1 below, and subjected to measuring an ultraviolet and infrared blocking effect.

To evaluate the ultraviolet and infrared blocking effect, a polycarbonate sheet was used as a control.

Here, infrared blocking agents having a particle size of 50 μm were used, and the plastic sheets were manufactured so that the skin layer had a thickness of 0.25 mm.

For the ultraviolet and infrared blocking effect, transmittance was measured in a 300 to 2,500 wavelength range in 2 nm increments using UV-VIS equipment, and a blocking rate in ultraviolet and infrared regions was calculated.

TABLE 1

| | | Skin layer | | | | | |
|---|---|---|---|---|---|---|---|
| | | | Ultraviolet | | | | |
| | | | blocking agent | | | | |
| | | | Tinuvin ® | Anti oxidant (wt %) | | | |
| | Base layer | | 234 | Irganox | Irgafos | Infrared blocking | |
| Classification | PC (wt %) | PC (wt %) | (wt %) | 1076 | 168 | agent (wt %) | |
| Sample 1 | 100 | 91.955 | 7 | 0.5 | 0.5 | Tungsten oxide | (0.045) |
| Sample 2 | 100 | 91.925 | | | | Tungsten oxide | (0.075) |
| Sample 3 | 100 | 91.895 | | | | Tungsten oxide | (0.105) |
| Sample 4 | 100 | 91.95 | | | | Aluminum-doped | (0.05) |
| | | | | | | tungsten oxide | |
| Sample 5 | 100 | 91.915 | | | | Aluminum-doped | (0.085) |
| | | | | | | tungsten oxide | |
| Sample 6 | 100 | 91.88 | | | | Aluminum-doped | (0.12) |
| | | | | | | tungsten oxide | |
| Sample 7 | 100 | 91.95 | | | | Zinc oxide | (0.05) |
| Sample 8 | 100 | 91.932 | | | | Zinc oxide | (0.068) |
| Sample 9 | 100 | 91.915 | | | | Zinc oxide | (0.085) |
| Sample 10 | 100 | 91.923 | | | | Tungsten oxide + | (0.06) |
| | | | | | | Aluminum-doped | (0.017) |
| | | | | | | tungsten oxide | |
| Sample 11 | 100 | 91.921 | | | | Tungsten oxide + | (0.053) |
| | | | | | | Aluminum-doped | (0.026) |
| | | | | | | tungsten oxide | |
| Sample 12 | 100 | 91.923 | | | | Tungsten oxide + | (0.068) |
| | | | | | | Aluminum-doped | (0.009) |
| | | | | | | tungsten oxide | |
| Sample 13 | 100 | 91.921 | | | | Tungsten oxide + | (0.045) |
| | | | | | | Aluminum-doped | (0.034) |
| | | | | | | tungsten oxide | |

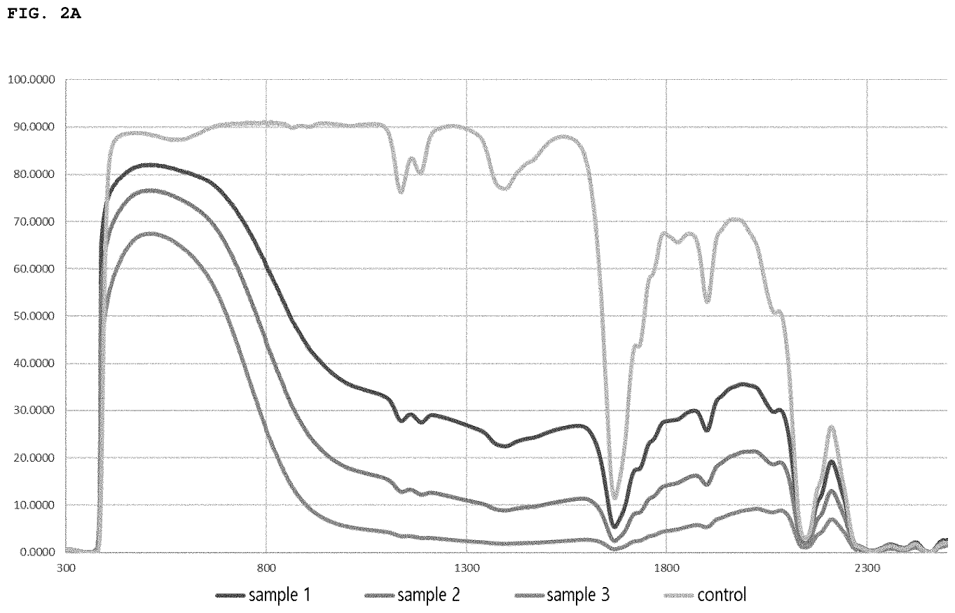

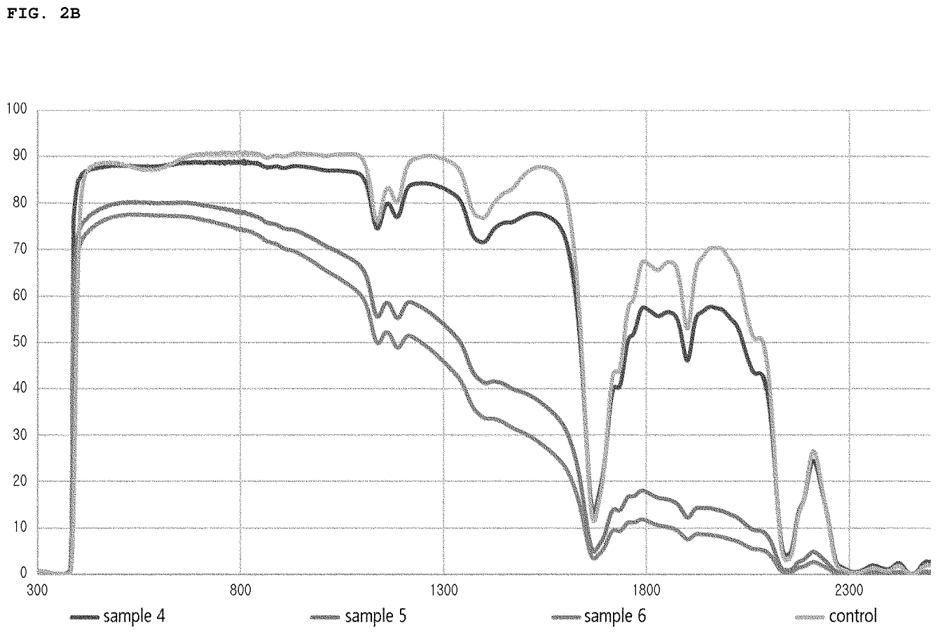

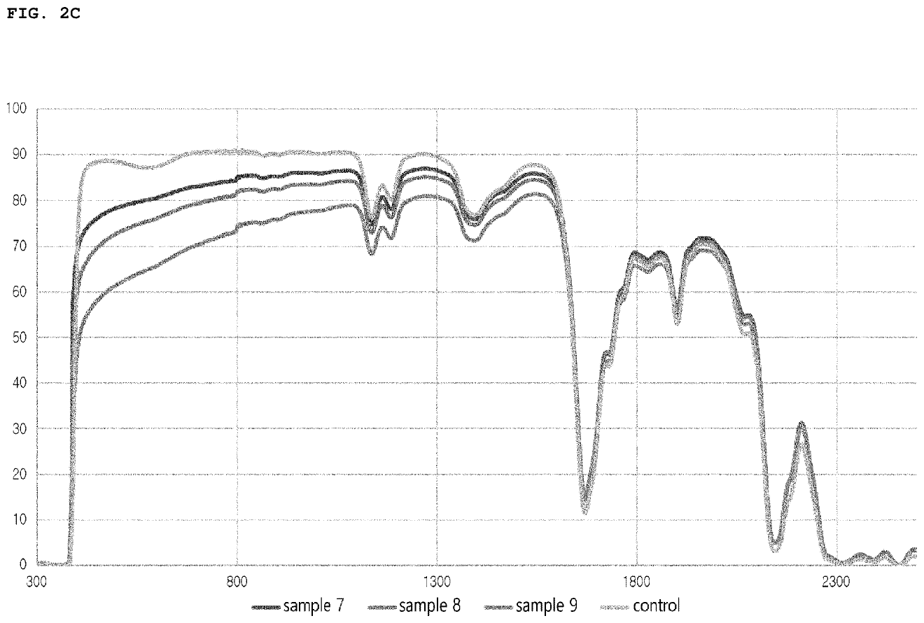

Referring to FIGS. 2A to 2C, as a result of comparing Samples 1 to 9, it can be seen that as the content of the infrared blocking agents in the skin layer increases, the infrared blocking effect increases proportionally.

Additionally, as a result of comparing tungsten oxide, aluminum-doped tungsten oxide, and zinc oxide, sheets including tungsten oxide have the best infrared blocking effect, followed by those including aluminum-doped tungsten oxide and zinc oxide.

Summarizing the above results, it is judged that it is preferable to use 0.075% or more of tungsten oxide in order to block 70% or more of infrared rays (780 to 2500 nm wavelength) while maintaining a visible ray transmittance (400 to 780 nm wavelength) 70% or more.

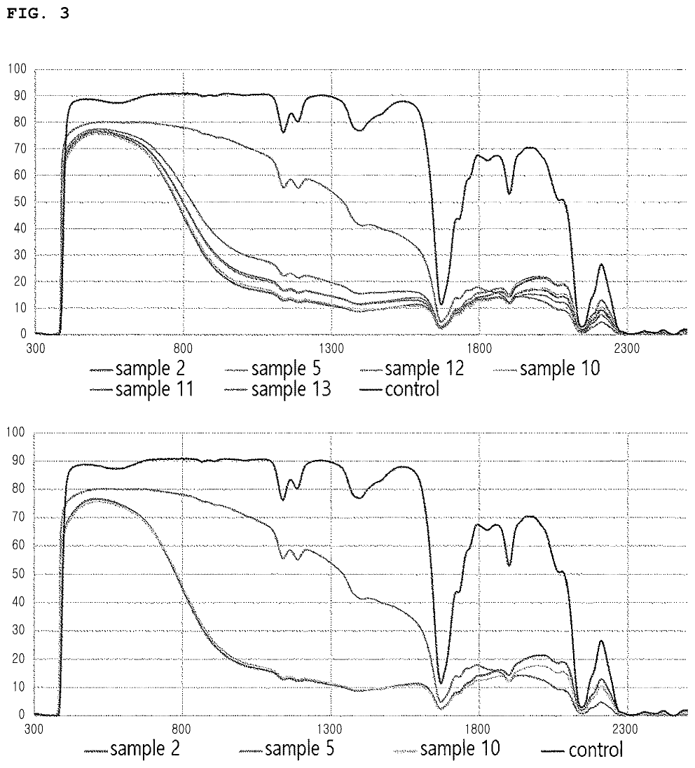

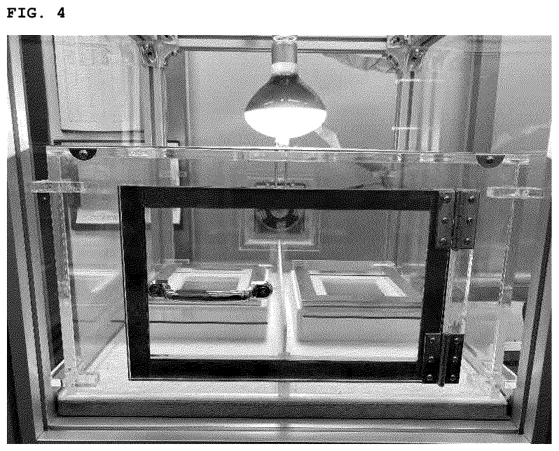

Additionally, referring to FIG. 3, it can be seen that compared to sheets using tungsten oxide, aluminum-doped tungsten oxide, or zinc oxide alone, infrared blocking efficiency of sheets using a mixture of these infrared blocking agents is superior. In particular, it can be seen that Sample 10, which uses a mixture of tungsten oxide and aluminum-doped tungsten oxide in an 8:2 ratio, has a superior infrared blocking efficiency over all other samples using a mixture of infrared blocking agents, as well as over samples using a single infrared blocking agent.

As a result, the present disclosure may exhibit the most excellent ultraviolet and infrared blocking effect by including tungsten oxide and aluminum-doped tungsten oxide, which are infrared blocking agents, in a weight ratio of 8:2 in the skin layer.

### Test Example 2: Analysis of Temperature Rise Inhibition Effect

A temperature rise inhibition effect in Sample 10 of Test Example 1 and the control was analyzed.

After installing Sample 10 and the control in a closed space, the temperature rise inhibition effect was measured for 120 minutes under the radiation of an infrared lamp.

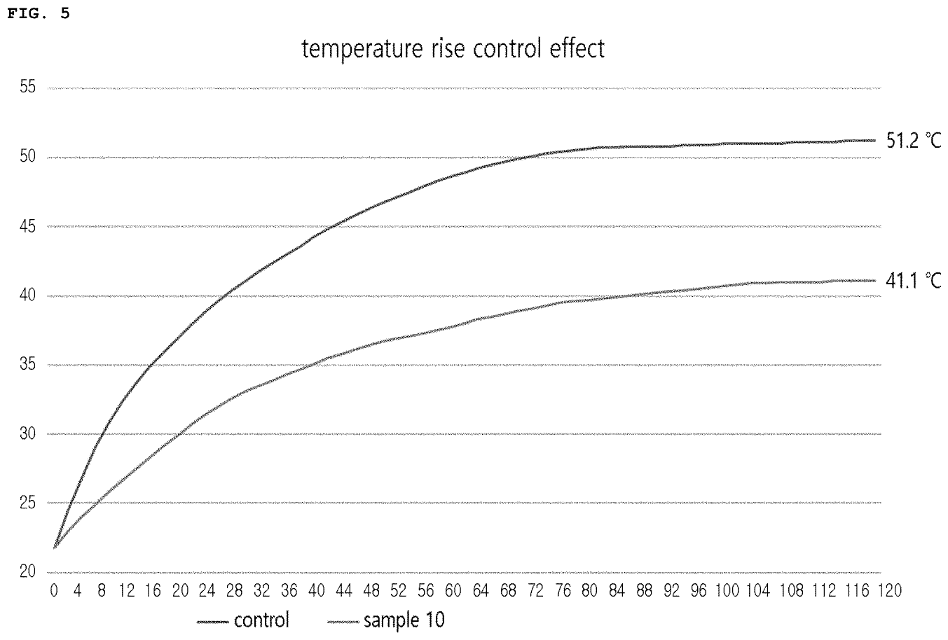

Referring to FIG. 5, it can be seen that the temperature of the control rose to 51.2° C. after 120 minutes, while the temperature of Sample 10 rose to 41.1° C.

As a result, this indicates that the plastic sheet according to the present disclosure inhibits temperature rise by about 10.1° C. compared to the general polycarbonate sheet, which is the control.

The present disclosure described above with reference to the accompanying drawings can be modified and changed by those skilled in the art, and such modifications and changes should be construed as falling within the scope of the present disclosure.

What is claimed is:

1. A transparent plastic sheet for blocking ultraviolet and infrared rays, the sheet comprising:
a base layer including a thermoplastic polymer; and
a skin layer provided on one or each side of the base layer and including a thermoplastic polymer, an ultraviolet blocking agent, an antioxidant, and an infrared blocking agent, wherein the base layer and the skin layer are formed by a co-extrusion method.

2. The sheet of claim 1, wherein the infrared blocking agent is one or more selected from the group consisting of zinc oxide, tungsten oxide, and aluminum-doped tungsten oxide.

3. The sheet of claim 2, wherein the infrared blocking agent includes 70 to 80% by weight of the tungsten oxide and 20 to 30% by weight of the aluminum-doped tungsten oxide.

4. The sheet of claim 1, wherein the infrared blocking agent has the form of particles having a particle size of 1 nm to 100 μm.

5. The sheet of claim 1, wherein the skin layer includes 83 to 98% by weight of the thermoplastic polymer, 0.3 to 15% by weight of the ultraviolet blocking agent, 0.1 to 2% by weight of the antioxidant, and 0.01 to 0.5% by weight of the infrared blocking agent.

6. The sheet of claim 1, wherein the skin layer has a thickness of 0.01 to 0.5 mm.

7. The sheet of claim 1, wherein the thermoplastic polymer is one or more selected from the group consisting of polycarbonate (PC), polyethylene terephthalate (PET), polyethylene terephthalate glycol (PETG), polycyclohexylene dimethylene terephthalate glycol (PCTG), polymethyl methacrylate (PMMA), and polystyrene (PS).

8. The sheet of claim 7, wherein the thermoplastic polymer is polycarbonate.
